(19) United States
(12) Patent Application Publication
(10) Pub. No.: US 2009/0133002 A1
(43) Pub. Date: May 21, 2009

(54) Method for benchmarking online business environments

(75) Inventor: Jai Ganesh, Bangalore (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Infosys Technologies Ltd., Bangalore (IN)

(21) Appl. No.: 12/291,158

(22) Filed: Nov. 6, 2008

(30) Foreign Application Priority Data
Sep. 28, 2007 (IN) 2188/CHE/2007

(51) Int. Cl. G06F 11/34

(52) U.S. Cl. 717/127

(57) ABSTRACT

A method to create web 2.0 index for an online business environment includes listing web 2.0 parameters, assigning a value based score to the listed web 2.0 parameters against each online business environment and computing the web 2.0 index for each online business environment. The method can create a benchmark between online business environments based on indicative of the computed web 2.0 indices. The web 2.0 index for an online business environment is the calculated by aggregating the value based scores assigned to individual web 2.0 parameters. The list of web 2.0 parameters for an online business environment captures content index constituents, collaboration index constituents and commerce index constituents.

### BACKGROUND OF THE INVENTION

The invention relates generally to benchmarking online business environments, specifically a method to benchmark online business environments based on web 2.0 indices.

Web 2.0 refers to the adoption of open technologies and architectural frameworks to facilitate participative computing. Web 2.0 is about collaborative and participative computing wherein users communicate and collaborate while at the same time contribute and participate.

Web 2.0 is shaping the way users work and interact with information on the web by shifting the focus to the user of the information. Web 2.0 relies heavily on creating and leveraging network effect by attracting a large number of participants and enabling interactions between them. Web 2.0 is about harnessing the potential of the Internet in a more collaborative and peer-to-peer manner through mechanisms to create enhanced customer experience, collaboration and co-creation of value. Mechanisms such as such as Wikis, RSS, Web services, blogs, podcasts, instant messaging etc. act as enablers towards this. Web 2.0 and has more to do with the mindset change to facilitate collaborative participation and leverage the collective intelligence of peers.

Web 2.0 will adopt and leverage the Web to play a critical role in facilitating peer-to-peer linkages. The challenge for Web 1.0 (as we would like to call the earlier wave of Internet) has been to involve the end users in a collaborative seamless peer-to-peer fashion in an economical and reliable manner and at the same time ensuring rich user experience. Rich user experience is a critical aspect of Web 2.0 and plays an important role in encouraging collaborative information exchange.

Online business environments using Web 2.0 has the potential to not only transform peer-to-peer collaboration, but also inter-entity collaborations and commerce by enabling various types and combinations of business-to-consumer (B2B), business-to-business (B2B), consumer-to-consumer (C2C), business-to-enterprise (B2E) business-to-government (B2G) etc. collaboration and commerce. Web 2.0 has the potential to not only enable rich peer-to-peer interactions but also enable collaborative value creation across online business environments. These could be scenarios such as Rich Internet Applications (RIA) based delivery tracking system leveraging Web 2.0 standards for desktop-like rich functionality on client side within a web page of online business environments. There are opportunities such as providing rich information on all the convergent services subscribed to by a consumer (including third party services) leveraging Web 2.0 standards which could be achieved through the use of Mashups based on content from multiple sources (exposed using APIS, RSS Feeds, Web Services etc.) to create new services.

In the view of foregoing, it is important for online business environments to evaluate their web 2.0 implementations and plan web 2.0 initiatives to compete with their peer groups. Currently, there is no method available for online business environments to evaluate their web 2.0 implementations, to benchmark their web 2.0 implementations against their peer online business environments group and plan their web 2.0 strategies accordingly.

Accordingly, there is a need for a method to enable online business environments to evaluate their web 2.0 implementations to benchmark their web 2.0 implementations against their peer online business environments group and help the online business environment to arrive at recommendations, best practices and road maps for web 2.0 initiatives.

### SUMMARY OF THE INVENTION

A method to create web 2.0 index for an online business environment is disclosed. The method preferably includes the steps of listing web 2.0 parameters, assigning a value based score to the listed web 2.0 parameters against each online business environment and computing the web 2.0 index for each online business environment. The method may be used to create a benchmark between online business environments based on the computed web 2.0 indices. The web 2.0 index for an online business environment is the calculated by aggregating the value based scores assigned to individual web 2.0 parameters. The list of web 2.0 parameters for an online business environment captures content index constituents, collaboration index constituents and commerce index constituents. The method enables the online business environments to evaluate their web 2.0 implementations, to benchmark their web 2.0 implementations against their peer online business environments group and help the online business environment to arrive at recommendations, best practices and road maps for web 2.0 initiatives.

These and other features, aspects, and advantages of the present invention will become better understood when the following detailed description is read with reference to the accompanying drawings in which like characters represent like parts throughout the drawings, wherein:

### BRIEF DESCRIPTION OF THE DRAWINGS

FIG. 1 is a flow diagram illustrating a method for benchmarking online business environments, in one embodiment of the present technique;

FIG. 2 is a schematic representation of a system used for benchmarking online business environments, in one embodiment of the present technique; and

FIG. 3 is a system illustrating a generalized computer network arrangement, in one embodiment of the present technique.

### DETAILED DESCRIPTION

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

The invention relates in general to benchmark online business environments, specifically a method to benchmark online business environments based on web 2.0 indices.

As will be appreciated by people skilled in the art, to best understand the present invention it is important to be familiar with the definitions in which it is used.

The term “online business environment” as used herein, refers to the presence of a business environment on the World Wide Web. The business environments includes, but not limited to, retail, banking, insurance, media, automotive, healthcare, education, government, telecom, travel and transport industries.

The term “web 2.0 parameter” as used herein, refers to a parameter adapted to capture web 2.0 features such as, but not limited to, rich user experience, peer-to peer, network effect, collective intelligence, web as the platform, collaboration, and modularity.

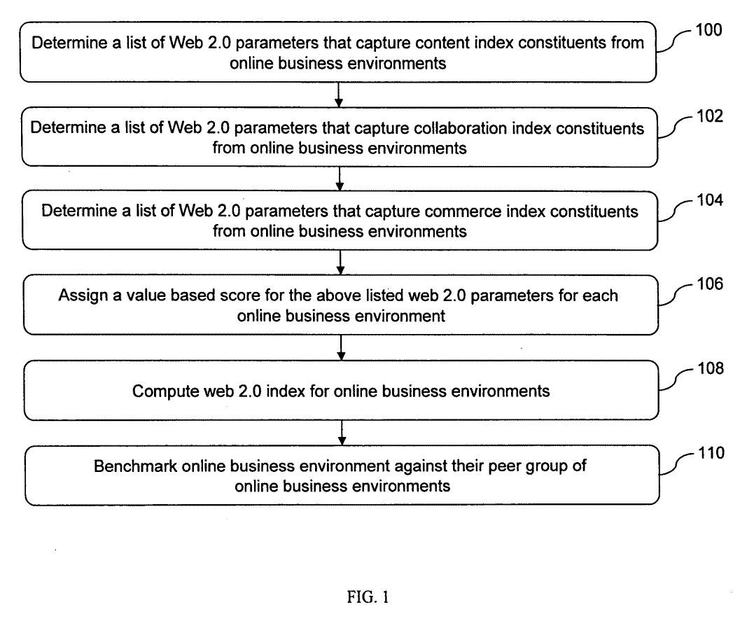

Referring now to figures, FIG. 1 is a flow diagram depicting a method to benchmark at least two online business environments. The method starts in step 100, wherein a list of web 2.0 parameters capturing content index constituents (hereinafter, referred to as “content index parameter”) from the online business environments. In one exemplary embodiment of the present invention, the content index parameters for an online retail business environment are listed as shown in Table 1.

At step 102, a list of web 2.0 parameters capturing content index constituents (hereinafter, referred to as “content index parameter”) from the online business environments are determined. In one exemplary embodiment of the present invention, the content index parameters for an online retail business environment are listed as shown in Table 1. At step 104, a list of web 2.0 parameters capturing commerce index constituents (hereinafter, referred to as “commerce index parameter”) from the online business environments are determined. In one exemplary embodiment of the present invention, the content index parameters for an online retail business environment are listed as shown in Table 1.

TABLE 1

| Content Index | | Collaboration Index | | Commerce Index | |
|---|---|---|---|---|---|
| Parameters | | Parameters | | Parameters | |
| 1. | Unique user experiences (RIA | 1. | Customer peer-to-peer | 1. | End user product |
| | driven) functionalities | | network (Blogs, Wikis, | | Customizations |
| 2. | Dynamic user help (peer-to-peer | | Discussion forums, Chat) | 2. | Contextual help (Live |
| | or central) | 2. | Collective Intelligence (User | | agent chat) |
| 3. | Data Feeds | | Reviews, Tagging etc.) | 3. | Voice based help (VoIP) |
| | (RSS/ATOM/XML/JS) | 3. | Collaborative product | 4. | Product service |
| 4. | Podcasts/Vodcasts | | customizations | | comparisons (across |
| 5. | Tag based search and | 4. | Bookmarks sharing | | brands, end user |
| | information retrieval | 5. | Ease of new user participation | | recommendations) |
| 6. | Search results linked to end user | 6. | User assigned news item | | |
| | rankings | | rankings | | |
| 7. | Rich content visualizations | 7. | End user content upload | | |
| 8. | Mobile version | 8. | Collaborative content creation | | |
| 9. | End user content customizations | | | | |
| 10. | Aggregation (Mashups) | | | | |

In Step 106, the user assigns a value based score for the content index parameters, collaboration index parameters, commerce index parameters against each online business environment.

In one exemplary embodiment of the present invention, the user provides a value based score on a 3 point scale. The user will award a score ‘0’ if the web 2.0 parameter does not exist in the online business environment. The user will award a score ‘1’ if the presence of web 2.0 parameter is in rudimentary stage or undeveloped stage and a score ‘2’ if the presence of web 2.0 parameter is in advanced stage or developed stage in the online business environment. The user completes the above process of scoring on a 3 point scare for all the online business environments.

In step 108, the web 2.0 index is computed for each online business environment. The web 2.0 index for an online business environment is computed by aggregating the scores awarded to content index parameter, collaboration index parameter and commerce index parameters. In one exemplary embodiment of the present invention, the web 2.0 index for an online business environment is computed by using the formula shown below:

$$Web 2.0 index = {\sum }_{score 0 , 1 , 2} ( Content + Collaboration + Commerce ) Index Parameter$$

Based on the above computed web 2.0 index for all online business environments, the online business environments will understand their web 2.0 index score, will understand their web 2.0 initiatives, and compare their web 2.0 index against peer group of online business environments and benchmark against peer group of online business environments as depicted in step 110. The method will also help the online business environments who scored less in web 2.0 index with a set of recommendations, best practices as well as road map for web 2.0 parameters which needs improvement.

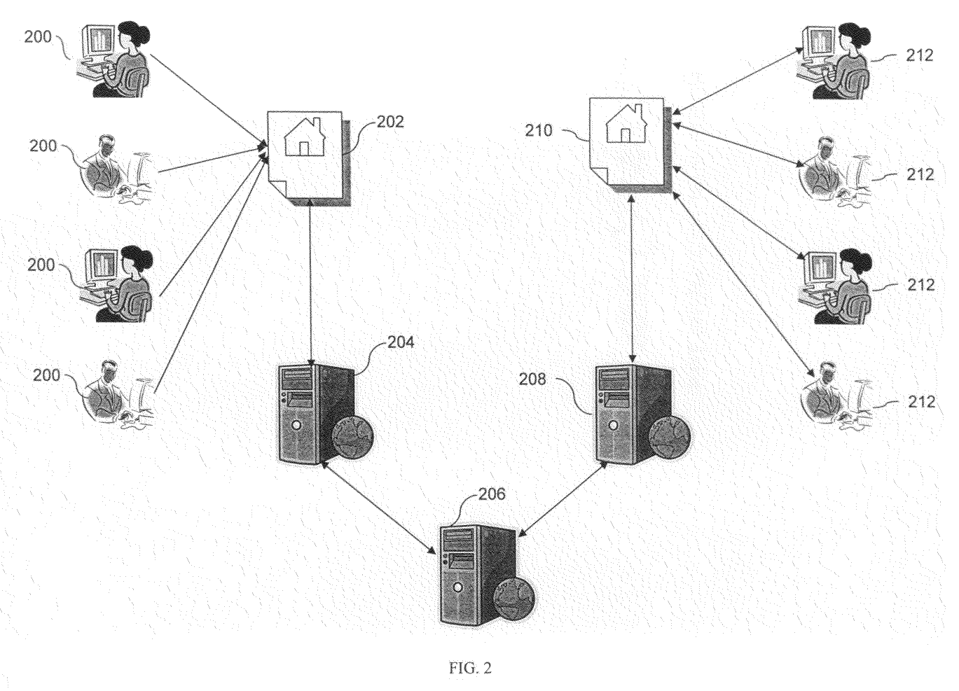

FIG. 2 is a schematic representation of a system used for benchmarking online business environments wherein at step 200, users will award a value based scores for each web 2.0 parameter against each online business environment (as explained above). The value based scores awarded by user group 200 are captured by ‘ratings capture engine with a web browser based interface’ as depicted in 202. The ratings capture engine 202 transfer the value based score data to ‘ratings capture database’ 204 wherein the value based scores against each parameter for each online business environment are stored. The ratings capture database 204 transfer the value based score for each online business environment to ‘data analytics engine’ 206. The data analytics engine 206 is responsible to carryout the web 2.0 index computations, benchmarking the online business environments against their peer group, road maps for improvement in web 2.0 initiatives for a low web 2.0 index scored online business environments.

The data analytics engine 206 is connected with a web server 208 wherein all the web 2.0 index information for the online business environments is stored. The web server 208 is responsible to interact with data analytics engine 206 for resolving the user queries on web 2.0 index for any online business environment. The web server 208 receives the user's query on computing web 2.0 index for an online business environment through a display engine with a web browser based interface 210. The display engine 210 receives queries for online business environments from users 212 wish to see the web 2.0 index for a list of online business environments.

In another embodiment of the present invention, upon receiving a query from users 212, the display engine 210 interacts with web server 208 to capture and display the web 2.0 indices for online business environments in the display engine 210. The web server 208 interacts with data analytics engine 206 to compute web 2.0 indices for online business environments. The data analytics engine 206 receives the required information from rating capture database 204.

Exemplary Computing Environment

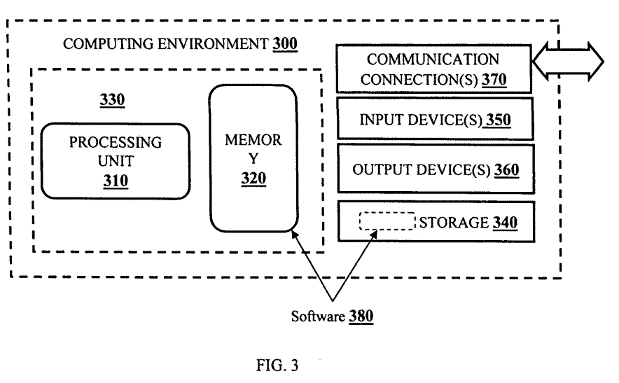

One or more of the above-described techniques may be implemented in or involve one or more computer systems. FIG. 3 illustrates a generalized example of a computing environment 300. The computing environment 300 is not intended to suggest any limitation as to scope of use or functionality of described embodiments.

With reference to FIG. 3, the computing environment 300 includes at least one processing unit 310 and memory 320. In FIG. 3, this most basic configuration 330 is included within a dashed line. The processing unit 310 executes computer-executable instructions and may be a real or a virtual processor. In a multi-processing system, multiple processing units execute computer-executable instructions to increase processing power. The memory 320 may be volatile memory (e.g., registers, cache, RAM), non-volatile memory (e.g., ROM, EEPROM, flash memory, etc.), or some combination of the two. In some embodiments, the memory 320 stores software 380 implementing described techniques.

A computing environment may have additional features. For example, the computing environment 300 includes storage 340, one or more input devices 350, one or more output devices 360, and one or more communication connections 370. An interconnection mechanism (not shown) such as a bus, controller, or network interconnects the components of the computing environment 300. Typically, operating system software (not shown) provides an operating environment for other software executing in the computing environment 300, and coordinates activities of the components of the computing environment 300.

The storage 340 may be removable or non-removable, and includes magnetic disks, magnetic tapes or cassettes, CD-ROMs, CD-RWs, DVDs, or any other medium which may be used to store information and which may be accessed within the computing environment 300. In some embodiments, the storage 340 stores instructions for the software 380.

The input device(s) 350 may be a touch input device such as a keyboard, mouse, pen, trackball, touch screen, or game controller, a voice input device, a scanning device, a digital camera, or another device that provides input to the computing environment 300. The output device(s) 360 may be a display, printer, speaker, or another device that provides output from the computing environment 300.

The communication connection(s) 370 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 300, computer-readable media include memory 320, storage 340, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

1. A method for benchmarking at least two online business environments comprises:
assigning a value based score for at least one web 2.0 parameter for the at least two online business environments;
computing web 2.0 index for the at least two online business environments; and
benchmarking the at least two online business environments by indicative of the web 2.0 indices.

2. The method according to claim 1, wherein the web 2.0 parameters are adapted to capture content index constituents from the online business environment.

3. The method according to claim 1, wherein the web 2.0 parameters are adapted to capture collaboration index constituents from the online business environment.

4. The method according to claim 1, wherein the web 2.0 parameters are adapted to capture commerce index constituents from the online business environment.

5. The method according to claim 1, wherein the web 2.0 index is aggregate of the value based scores assigned to the at least one web 2.0 parameter.

6. The method according to claim 1, wherein assigning of the value based score is provided through online service or offline service or both.

7. A computer program product comprising a computer usable medium having a computer readable program code embodied therein for benchmarking at least two online business environments, the program code causing a computer to:
assign a value based score for at least one web 2.0 parameter for the at least two online business environments;
compute web 2.0 index for the at least two online business environments; and
benchmark the at least two online business environments by indicative of the web 2.0 indices.

8. The computer program product as recited in claim 7, wherein the web 2.0 parameters are adapted to capture content index constituents from the online business environment.

9. The computer program product as recited in claim 7, wherein the web 2.0 parameters are adapted to capture collaboration index constituents from the online business environment.

10. The computer program product as recited in claim 7, wherein the assigning of score is provided through online service or offline service or both the web 2.0 parameters are adapted to capture commerce index constituents from the online business environment.

11. The computer program product as recited in claim 7, wherein the web 2.0 index is aggregate of the value based scores assigned to the at least one web 2.0 parameter.

12. The computer program product as recited in claim 7, wherein assigning of the value based score is provided through online service or offline service or both.
